(19) United States
(12) Patent Application Publication
(10) Pub. No.: US 2009/0176911 A1
(43) Pub. Date: Jul. 9, 2009

(54) Novel masterbatch thermoplastic delivery system

(76) Inventors: David Abecassis, Huntington, NY (US); Edward Wiegel, Baltimore, MD (US)

Correspondence Address: Bodner & O'Rourke, LLP;Suite 108, 425 Broadhollow Road, Melville, NY, 11747, US

(21) Appl. No.: 12/284,461

(22) Filed: Sep. 22, 2008

Related U.S. Application Data
(63) Continuation-in-part of application No. 11/593,454, filed on Nov. 6, 2006.
Application No. 11/593,454 is a continuation-in-part of application No. 11/801,993, filed on May 11, 2007.
Application No. 11/801,993 is a continuation-in-part of application No. 11/880,888, filed on Jul. 23, 2007.
Application No. 11/880,888 is a continuation-in-part of application No. 11/881,407, filed on Jul. 26, 2007.
Application No. 11/881,407 is a continuation-in-part of application No. 11/827,661, filed on Jul. 12, 2007.
Application No. 11/827,661 is a continuation-in-part of application No. 12/072,504, filed on Feb. 26, 2008.
(60) Provisional application No. 60/994,472, filed on Sep. 20, 2007.
(60) Provisional application No. 60/994,573, filed on Sep. 20, 2007.
(60) Provisional application No. 60/998,999, filed on Oct. 15, 2007.

(51) Int. Cl. C08J 3/22

(52) U.S. Cl. 523/351

(57) ABSTRACT

Clays and organoclays which are treated with resorcinol diphosphate and/or bisphenol diphosphate as general nanoparticle particle dispersants and replacements for quaternary amines. The two compounds are used as self-activating and self-dispersing nanoparticles by localizing themselves on the particle surface in a polymer matrix and acting as a nanoparticle dispersants in general, as well as resulting in exfoliation of clays. The exfoliate clays may be used in polymers in lieu of other organic treatments. When these clays exfoliate poorly in a given thermoplastic, they can be added in high loading rates to polymethylmethacrylate and the PMMA-clay masterbatch added to the plastic where the organoclay performed poorly. The resulting material is a desirable nanocomposite material, with good exfoliation of the organoclay obtained in the final receiving thermoplastic.

This application claims priority on U.S. Provisional Patent Application Ser. No. 60/994,472 filed Sep. 20, 2007, Ser. No. 60/994,573 filed Sep. 20, 2007 and Ser. No. 60/998,999 filed Oct. 15, 2007 the disclosures of which are incorporated herein by reference. This application is also a continuation in part of U.S. application Ser. No. 11/593,454 filed Nov. 6, 2006 and U.S. application Ser. No. 11/801,993 filed May 11, 2007 and U.S. application Ser. No. 11/880,888 filed Jul. 23, 2007 and U.S. application Ser. No. 11/881,407 filed Jul. 26, 2007 and U.S. application Ser. No. 11/827,661 filed Jul. 12, 2007 and U.S. application Ser. No. 12/072,504 filed Feb. 28, 2008 the disclosures of which are incorporated herein by reference.

### FIELD OF THE INVENTION

The invention is directed towards the field of thermoplastic nanocomposite additives. The invention relates to the delivery of RDP (resorcinol diphosphate) treated clays into thermoplastics via the use of a pre-blend compounding step whereby the RDP treated clay is first exfoliated into the matrix of the masterbatch plastic prior to addition to the final thermoplastic nanocomposite plastic. The masterbatch plstic may be polymethyl-methacrylate (PMMA), ethylene vinyl acetate (EVA), or acrylonitrile butadiene styrene (ABS).

### BACKGROUND OF THE INVENTION

The use of nano-particle additives has been driven in many ways, either by processing or chemical treatment in the attempt to uniformly distribute the particles throughout the polymer in order to obtain a uniform material with homogenous properties. In some specific instances the processor tries to obtain spatial localization of nano-particle fillers within the material, as is the case with many electronic nano-composites. Nanoclays and other additives such as carbon nanotubes are most often treated or processed for maximum dispersion.

Exfoliated clays have a variety of applications. One application of these clays is in polymer clay nanocomposites. These clay nanocomposites are polymer matrices containing platelet shaped clay particles that have sizes of a few nanometers thick. Because of their high aspect ratios and their high surface area, clay can import unique combinations of physical and chemical properties to make the polymer.

The clay particles used in nanocomposites occur naturally as layered silicates. In order to obtain the benefits of the clay particles, the clay particles are preferably exfoliated, i.e. delaminated and uniformly dispersed in the polymer matrix.

When clay is blended with a polymer, one of the problems that can be encountered is the incompatibility between the hydrophilic polymer and the hydrophilic clay particle surface. As a result of this incompatibility, there is a risk that the exfoliated clay particles do not remain exfoliated and it can be difficult to achieve a uniform dispersion of the clay particles throughout the blend. To solve this problem, clays have been treated with an organic compound to create an organoclay. An organoclay has an organic material bonded to a surface of the clay particle that permits the clay particle to remain exfoliated and enhances the blending of the hydrophilic clay in the hydrophilic polymer. The bonding of the organic material to the clay to produce the organoclay requires a number of steps in the process. One type of material that has been used to form the organoclays has been an ammonium compound such as a quaternary ammonium compound. In order to form the organoclays with a quaternary ammonium compound, the quaternary ammonium compound is grafted to the clay particles.

While grafted polymers onto clay particles has aided exfoliation of clay particles, it does not typically provide complete exfoliation. As a result, there is a need for an improved process of exfoliating clays. In addition, organoclays including the invention described in the following application; have different rates of exfoliation in a given thermoplastic. Therefore to broaden the applicability of RDP treated organoclays into different thermoplastic polymers, the following addition to a primary masterbatch plastic concentrating the organoclay into a palletized encapsulated delivery system has been developed.

### OBJECTS OF THE INVENTION

It is an object of the invention to provide an improved process for exfoliating clay.

It is also an object of the invention to provide improved exfoliated clays.

It is a still further object of the invention to provide improved blends of exfoliated clays and resorcinol diphosphate and/or bisphenol diphosphate.

It is yet another object of the invention to better deliver exfoliating particles to the polymer matrix by adding the resorcinol diphosphate and/or bisphenol diphosphate treated clay to a polymer where it gets high exfoliation rates, prior to adding the latter compounded plastic to a thermoplastic material where the RDP/BDP treated clay does not exfoliate well. The final polymer blend contains exfoliated organoclay particles which compatiblize the two plastics into a uniform nanocomposite thermoplastic with well exfoliated clay particles evenly distributed in the hybrid polymer matrix. In this case the primary plastic where the RDP /and or BDP treated clay is concentrated is referred to as the masterbatch plastic. It is the formation of this masterbatch that is a primary object of this invention.

### BRIEF DESCRIPTION OF THE DRAWINGS

FIG. 1 shows a masterbatch transmission image of PMMA masterbatch in polypropylene.

### SUMMARY OF THE INVENTION

The present invention is an organic treatment carried out typically in a single processing step, which replaces the need for multi-stage chemical treatments and elaborate processing of the polymer in order to obtain homogeneity of the final nano-composite material when the additive is mixed with a polymer.

The present invention includes a method of forming an exfoliated clay by blending a clay with resorcinol diphosphate (RDP) such that the resorcinol diphosphate coats at least a portion of the surface of the clay platelet, thereby providing improved exfoliation. Alternatively, the clay platelet may be blended with bisphenol diphosphate (BDP). The chemical dispersants for the invention have no precedent in their use which would have indicated their applicability for such dispersion. Issued patents for BDP deal with it's use as a flame retardant or as a precursor for polycarbonate synthesis. As for the RDP; its described uses are as a flame retardant additive or as a plasticizer for plastic impact modification. It is often used in conjunction with complex multicomponent packages designed to boost plastic mechanical or flame retardant properties.

The present invention also includes the composition formed from the blending of the clay with either resorcinol diphosphate or bisphenol diphosphate or blends thereof. In a preferred composition, there is about 99% to about 50% by weight clay with the balance RDP. Similarly, another preferred composition is 99% to about 50% by weight BDP. In a more preferred embodiment this is about 85 to about 12% by weight diphosphate with the balance clay. In this invention, the RDP or BDP or blends thereof physically coat the clay platelet and allow it to exfoliate. While it is possible to have compositions with more than 50% by weight RDP or BDP, in such compositions the RDP and/or BDP acts as a plasticizer which may not always be a desired property for the particular application.

Other preferred compositions include blends of 95% to about 70% by weight clay with the balance RDP and/or BDP.

In forming the blends of the present invention, it is preferred that the diphosphate material be heated to about 50° C. to about 100°. The liquid can be sprayed on to the clay and then the composition can be mechanically mixed to blend the clay and diphosphate together. Other means of mixing the clay and the diphosphate can be employed. It is also preferred that the diphosphate be heated to a temperature below its vapor point so that the diphosphate material is not lost.

Once the clay has been exfoliated by blending with RDP or BDP, the composition can be used in a variety of polymers and polymer blends. In a preferred embodiment, there is about 1% to about 25% by weight of the exfoliated clay blend of clay and diphosphate with the balance the polymeric material.

In order to enhance exfoliation in thermoplastics where good exfoliation with organoclays does not usually occur, the RDP/and or BDP treated clay is pre-compounded into polymethylmethacrylate (PMMA), ethylene vinyl acetate (EVA), or acrylonitrile butadiene styrene (ABS) where it's exfoliation rate is high. This concentrated pellet of clay and phosphate blend PMMA, ABS or EVA polymer can be used as an additive with success in thermoplastics where the RDP and or BDP treated organoclay do not perform well on it's own without this pre-compounding step.

The improved polymer-exfoliate clay blends of the present invention may be used in a variety of applications. The properties of the polymer blends of the present invention includes improved barrier properties including water and oxygen barrier properties. There are also improved vapor and moisture barrier properties in these compositions. The compositions of the present invention also have increased UV stability and improved flame retardant properties.

The compositions of the present invention also have improved processability. The exfoliated clay in the polymer keeps the viscosity of the polymer higher at higher temperatures with less back flow in extrusion and injection molding equipment. A

### DETAILED DESCRIPTION OF THE INVENTION

The clays used in the present invention are typically a smectite clay. A smectite clay is a natural or synthetic clay mineral selected from the group consisting of hectorite, montmorillonite, bentonite, beidelite, saponite, stevensite and mixtures thereof. A particularly preferred choice for the smectite is montmorillonite.

The present invention is an organic treatment carried out typically in a twin processor, which replaces the need for multi-stage chemical treatments and elaborate processing of the polymer in order to obtain homogeneity of the final nano-composite material when the additive is mixed with a polymer.

The present invention includes a first step of forming an exfoliating clay by blending a clay with a diphosphate such as resorcinol diphosphate (RDP). The diphosphate coats at least a portion of the surface of the clay platelet, thereby providing improved exfoliation in thermoplastics. Alternatively, the clay platelet may be blended with bisphenol diphosphate (BDP) or a blend of RDP and BDP. The chemical dispersants for the invention have no precedent in their use which would have indicated their applicability for such dispersion. Issued patents for BDP deal with it's use as a flame retardant or as a precursor for polycarbonate synthesis. As for the RDP; it's described uses are as a flame retardant additive or as a plasticizer for plastic impact modification. It is often used in conjunction with complex multicomponent packages designed to boost plastic mechanical or flame retardant properties.

The present invention also includes the composition formed from the blending of the clay with either resorcinol diphosphate or bisphenol diphosphate or blends thereof. In a preferred composition, there is about 99% to about 50% clay with the balance RDP. Similarly, another preferred composition is 99% to about 50% BDP. In this invention, the RDP or BDP or blends thereof physically coat at least a portion of the clay platelet and allows the clay platelet to exfoliate. While it is possible to have compositions with more than 50% RDP or BDP, in such compositions the RDP and/or BDP acts as a plasticizer which may not always be a desired property for the particular application. Other preferred compositions include blends of 99% to about 80% clay with the balance RDP and/or BDP.

In forming the blends of the present invention, it is preferred that the diphosphate material be heated to about 50° C. to about 100°. The liquid diphosphate can then be sprayed on to the clay. It can also be added at room temperature if the particles are fluidized in a solid particle vortex. The composition containing the clay and the diphosphate can be mechanically mixed to blend the materials together. Other suitable means of mixing the clay and the diphosphate can be employed. It is also preferred that the diphosphate be heated to a temperature below its vapor point so that the diphosphate material is not vaporized.

The composition of the present invention may include about 1 to about 25% by weight diphosphate and 75% to about 99% by weight clay. The blend of clay and diphosphate is blended with PMMA, EVA or ABS. In this blend of intercalated clay and PMMA, EVA or ABS there is about 5% to about 60% by weight intercalated clay and 40% to about 95% by weight PMMA, EVA or ABS. The blend of PMMA, EVA or ABS and intercalated clay is mixed with a thermoplastic. The total amount of clay in the blended composition with the thermoplastic is about 0.1 to about 10% by weight clay. The masterbatch blend of diphosphate, clay and either PMMA, EVA or ABS are blended with a thermoplastic. There is preferably about 5% by weight to about 40% by weight masterbatch with the balance thermoplastic polymer. In a more preferred embodiment there is about 5% to about 20% masterbatch with the balance thermoplastic. The final composition of the overall blend preferably contains about 0.1% by weight to about 5% by weight clay.

Once the clay has been intercalated by blending with RDP or BDP, the composition can be used in a variety of polymers and polymer blends. In a preferred embodiment, there is about 1% to about 25% by weight of the exfoliated clay blend with the balance final the polymeric material. The present invention may also be used with organoclays as well to enhance their exfoliation.

The second step involves taking the RDP/and or BDP treated organoclay or nanoparticle and dispersing it in high concentrations in polymethylmethacrylate, ethylene vinyl acetate or acrylonitrile butadiene styrene. A preferred embodiment is to load the PMMA, EVA or ABS blend with diphosphate treated clay for use as a thermoplastics additive masterbatch delivery system.

The improved polymer exfoliate clay blends of the present invention may be used in a variety of applications. The properties of the polymer blends of the present invention includes improved barrier properties including water and oxygen barrier properties. There are also improved vapor and moisture barrier properties in these compositions. The compositions of the present invention also have increased UV stability and improved flame retardant properties.

The compositions of the present invention also have improved processability. The exfoliated clay in the polymer keeps the viscosity of the polymer higher at higher temperatures with less back flow in extrusion and injection molding equipment.

The preferred nanocomposite masterbatch is a blend of polymeric material selected from a group consisting of PMMA, EVA or ABS and exfoliated clay coated with diphosphate. The nanocomposite may be added to a variety of thermoplastic polymers, including but not limited to polyethylene (PE), polypropylene(PP), polyvinyl chloride (PVC), high impact polystrene (HIPS), Styrene-Acryl -Nitrile (SAN), Thermoplastic polyurethane(TPU), Polyphenylene sulfide (PPS), polyamide imide copolymer (PAI), polyetheretherketone (PEEK), polyphenylene oxide (PPO), polysulfone, polyester, polystyrene, polyacetal thermoplastic, thermoplastic elastomer (TPE), polyether sulfone, polyphenylene sulfide (PPS), polypthalamide (PTA), polycarbonate, polyacrylonitrile (PAN).

RDP and BDP are useful as a general dispersant for nanoparticles in a polymer matrix. Both of these diphosphates increase the exfoliation rate of nanoclays. The diphosphates replace the use of quaternary ammonium salts in organoclays used in nanocomposite polymers in order to achieve exfoliation inside the polymer matrix. The clays useful in the present invention include both natural and synthetic clays. The synthetically prepared smectite clays can include montmorillonite bentonite, beidelite, hectorite, saponite and stevensite clays.

The RDP/BDP blends of the present invention avoid the use of quaternary ammonium salts in organoclays used in nano-composite polymers in order to achieve exfoliation inside the polymer matrix. The clays can include a Wyoming variety of swelling bentonite and similar clays, and hectorite, which is a swelling magnesium-lithium silicate clay, as well as, synthetically prepared smectite-type clays, such as montmorillonite, bentonite, beidelite, hectoritesaponite, and stevensite.

The nanoparticles useful in the present invention can include instead of clay at least one metal oxide, halide, oxyhalide or chalcogenide salt. Other nanoparticles can be selected from the group consisting of aluminosilicates, ZnS, ZnSe, PbSe, CdS and CdSe nanoparticles. Still other nanoparticles can include at least one metal fluoride or chloride salt.

The nanoparticles of the present invention have particular applicability in the formation of semi-conductors. The inorganic nanoparticles can include at least one Group III, IV or V semiconductor element, or at least one Group III V, Group II V, or Group II VI semiconductor compound, doped with one or more active ions.

Other inorganic nanoparticles can include at least one Group III, IV, or V semiconductor element selected from the group consisting of Si, Ga and As, doped with one or more active ions.

Also useful are inorganic nanoparticles that contain at least one Group III V semiconductor compound selected from the group consisting of GaAs, GaN and InN.

The nanoparticulate material of the present invention can include magnesium oxide nanoparticles and multicomponent oxide spheres that include a silica sphere coated with another oxide shell.

The nanoparticle material can be selected from the group consisting of a nanoclay, a carbon nanofiber, a polyhedral oligomeric silsesquioxane (POSS), a nanoparticle mineral, nanoparticle silica, nanoparticle alumina, nanoparticle mica, nanoparticle graphite, nanoparticle carbon black, nanoparticle fumed carbon, nanoparticle fly ash, glass nanospheres, ceramic nanospheres, and a combination thereof.

The nanoparticle material can also include at least one of Co, Fe, Ni, CoFe, NiFe, CO₂O₃, FeO, Fe₂O₃, Fe₃O₄, NiO, and ferrites including MFe₂O₄ where M comprises one of Co and Ni, and the hard magnetic material comprises at least one of CoPt, FePt, SmCo-based alloys, and NdFeB-based materials.

The nano-particles can also include Ti/Sb mixed oxide nanoparticles .

The present invention also includes a metal nanoparticle that contains at least one noble metal atom selected from the group consisting of gold, silver, platinum, and palladium.

Other nanoparticles can include at least one noble metal atom selected from the group consisting of gold, silver, platinum, palladium, iridium, rhenium, mercury, ruthenium, rhodium, copper, and osmium and/or at least one non-noble metal atom selected from the group consisting of iron, cobalt, vanadium, chromium, manganese, molybdenum, nickel, lead, cadmium, niobium, technetium, and tungsten.

There can also be metal based nanoparticles containing at least one compound selected from the group consisting of gold hydroxide, gold acetate, gold chloride, platinum chloride, silver acetylacetonate, silver citrate, silver lactate, silver nitrate, platinum acetylacetonate, palladium acetylacetonate, palladium acetate, palladium hydroxide, ruthenium acetylacetonate, copper ethoxide, Fe(CO)₅, Fe₂(CO)₉, CO₂(CO)₈,V(CO)₆, Cr(CO)₆, Mn₂(CO)₁₀, Re₂(CO)₁₀, Ru₃(CO)₁₂, Mo(CO)₆, Os(CO)₅, Os₃(CO)₁₂, Ir₄(CO)₁₂, W(CO)₆, Tc₂(CO)₁₀, Ru(CO)₅, Rh(CO)₁₂, Pd(CO)₄, Pt(CO)₄, and platinum-1,3-divinyl-1,1,3,3,-tetramethyldisiloxane.

The metal oxide of the nanoparticle can be a metal oxide selected from the group consisting of aluminum triethoxide, aluminum isopropoxide, aluminum sec-butoxide, aluminum tri-the-butoxide, magnesium trifluoroacetylacetonate, magnesium methoxide, magnesium ethoxide, titanium methoxide, titanium ethoxide, titanium isopropoxide, titanium propoxide, titanium butoxide, titanium ethylhexoxide, titanium (triethanolaminato)isopropoxide, titanium bis(ethyl acetoacetato)diisopropoxide, titanium bis(2,4-pentanedionate)diisopropoxide, zirconium ethoxide, zirconium isopropoxide, zirconium propoxide, zirconium sec-butoxide, zirconium the-butoxide, aluminum di-s-butoxide ethylacetonate, calcium methoxyethoxide, calcium methoxide, magnesium methoxyethoxide, copper ethoxide, copper methoxyethoxyethoxide, antimony butoxide, bismuth pentoxide, chromium isopropoxide, tin ethoxide, zinc methoxyethoxide, titanium n-nonyloxide, vanadium tri-n-propoxide oxide, vanadium triisobutoxide oxide, iron ethoxide, tungsten ethoxide, samarium isopropoxide, iron isopropoxide, cobalt methoxyethoxide, and lanthanium methoxyethoxide. The nanoparticle can also include an organosilane, preferably an organofunctional silane.

Other materials that can be used as the nanoparticle can include cadmium sulfide; and polyphosphate, ferrite, and apatite. The nanoparticle can also contain at least one metal oxide, halide, oxyhalide or chalcogenide salt.

The nanoparticles can also be selected from the group consisting of aluminosilicates, ZnS, ZnSe, PbS, PbSe, CdS and CdSe nanoparticles. The nanoparticles can also include at least one metal fluoride or chloride salt.

A preferred embodiment of the invention is the addition of the nanoparticle to the PMMA, EVA or ABS by extruder-pelletizer; either single or twin screw.

### EXAMPLES

### Example 1

RDP treated sodium bentonite clay was loaded at 10% by weight RDP the balance clay using a dry-vortex fluidized addition process. The organoclay was added into thermoplastic PMMA at 30% by weight RDP clay bland balance PMMA using a Walter Pfeidzerer 30 mm twin screw co-axial extruder. The PMMA masterbatch was then added at 5% by weight organoclay with the balance final thermoplastic.

With polypropylene, the results obtained were as follows:

PP + PMMA masterbatch (5% final organoclay load)

| | |
|---|---|
| 139423 | Flex Modulus, psi |
| 3371 | Tensile Strength at Yield, psi |
| 2167 | Tensile Strength at Break, psi |
| 0.85 | Izod Impact Strength, ft. lbs./in. |
| 0.934 | Specific Gravity |

When compared to the virgin polypropylene, the flexural modulus value in particular was increased (FM=111659) by ˜12% over the control. Tensile at yield drops only slightly 3371/3481=only 4% drop in tensile at yield.

### Example 2

RDP treated sodium bentonite clay was loaded at 10% RDP by weight with the balance clay using a dry-vortex fluidized addition process. The organoclay was added into thermoplastic PMMA at 30% by weight RDP clay bland balance PMMA using a Walter Pfeidzerer 30 mm twin screw co-axial extruder. The PMMA masterbatch was then added at 5% by weight with the balance organoclay final thermoplastic.

In polycarbonate, another plastic where pure RDP/and or BDP treated clay had exfoliated at a poor rate; the results of using the PMMA masterbatch were also very encouraging:

| Properties | PC + PMMA-MB at 5% final organoclay load |
|---|---|
| Flex Modulus, psi | 383425/333942 control = 15% increase in F-M |
| Tensile Strength at Yiel, | 9483/8941 control = 6% increased T-Y |
| psi | |

Although other properties decreased in the polycarbonate such as Notched Izod impact, these enhanced properties are examples of increases obtained by the exfoliation of the masterbatched organoclay being introduced and compatiblized with the polycarbonate.

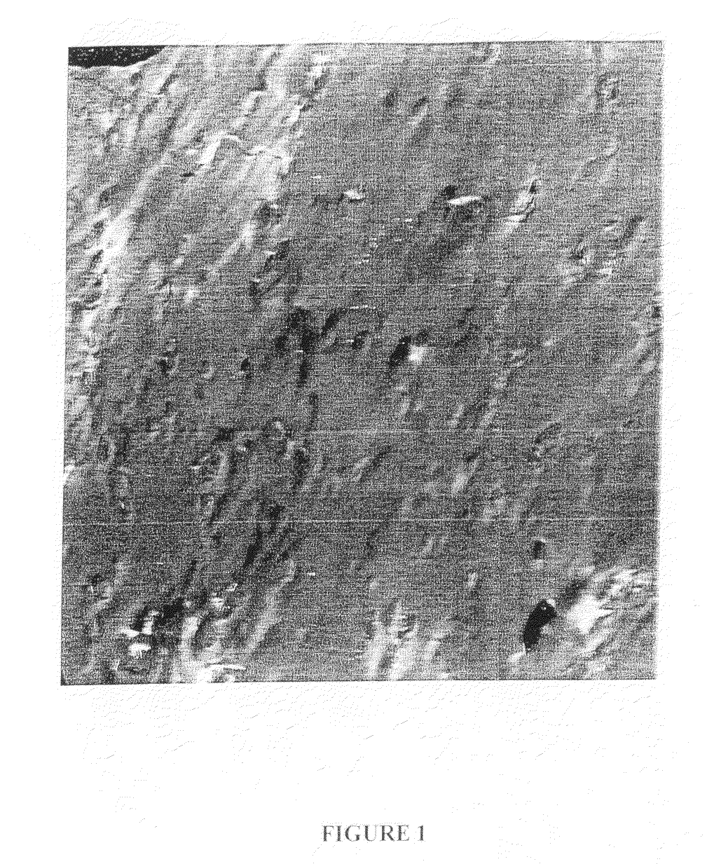

FIG. 1 shows a Masterbatch Transmission Image of PMMA masterbatch in Polypropylene The unusual uniformity of dispersion of the PMMA masterbatch inside the PP polymer matrix illustrates the microscopic structure achieved with PMMA masterbatched RDP-treated clay inside polymers where it's added.

What is claimed:

1. A thermoplastic composition comprising a thermoplastic polymer and a masterbatch, said masterbatch comprising a clay and a diphosphate, said clay being coated with said diphosphate over at least a portion of the surface of the clay, said masterbatch further comprising a polymeric material, said polymeric material consisting essentially of polymethylmethacrylate, ethylene vinyl acetate and acrylonitrile butadiene styrene.

2. The thermoplastic composition according to claim 1 wherein said clay is exfoliated in said polymeric material.

3. The thermoplastic composition according to claim 2 wherein said masterbatch is a nanocomposite.

4. The thermoplastic composition according to claim 3 wherein said diphosphate is rescorcinol diphosphate.

5. The thermoplastic composition according to claim 3 wherein said diphosphate is bisphenal diphosphate.

6. The thermoplastic composition according to claim 3 wherein said thermoplastic polymer is a polyvinyl chloride.

7. The thermoplastic composition according to claim 3 wherein said diphosphate coated clay comprises about 5 to about 60% by weight of the masterbatch.

8. The thermoplastic composition according to claim 7 wherein there is up to about 45% by weight of said masterbatch in said thermoplastic composition.

9. The thermoplastic composition according to claim 3 wherein said thermoplastic polymer is a polypropylene.

10. The thermoplastic composition according to claim 3 wherein said thermoplastic polymer is a polyethylene.

11. The thermoplastic composition according to claim 3 wherein said thermoplastic polymer is a high impact polystyrene (HIPS).

12. The thermoplastic composition according to claim 3 wherein said thermoplastic polymer is a styrene-acrylo-nitrile (SAN).

13. The thermoplastic composition according to claim 3 wherein said thermoplastic polymer is a thermoplastic polyurethane (TPU).

14. The thermoplastic composition according to claim 3 wherein said thermoplastic polymer is a polyamide.

15. The thermoplastic composition according to claim 3 wherein said thermoplastic polymer is a polycarbonate.

16. The thermoplastic composition according to claim 3 wherein said thermoplastic polymer is a polysulfone.

17. The thermoplastic composition according to claim 3 wherein said thermoplastic polymer is a is polyester.

18. The thermoplastic composition according to claim 3 wherein said thermoplastic polymer is a polystyrene.

19. The thermoplastic composition according to claim 3 wherein said thermoplastic polymer is a polyacetal thermoplastic.

20. The thermoplastic composition according to claim 3 wherein said thermoplastic polymer is a thermoplastic elastomer.

21. The thermoplastic composition according to claim 3 wherein said thermoplastic polymer is a polyamide-imide (PAI).

22. The thermoplastic composition according to claim 3 wherein said thermoplastic polymer is a polyetheretherketon (PEEK).

23. The thermoplastic composition according to claim 3 wherein said thermoplastic polymer is a polyphenylene oxide (PPO).

24. The thermoplastic composition according to claim 3 wherein said thermoplastic polymer is polyphenylene sulfide (PPS).

25. The thermoplastic composition according to claim 3 wherein said thermoplastic polymer is polyacrylonitrile (PAN).

26. A thermoplastic composition comprising a masterbatch and a thermoplastic polymer, said masterbatch comprising a nanoparticle said nanopartical comprising a diposphate, and either a metal oxide, halide oxyhalide, a chalcogenide salt or blends thereof.

27. The thermoplastic composition according to claim 26 wherein said diphosphate is rescorcinol diphosphate.

28. The thermoplastic composition according to claim 26 wherein said diphosphate is bisphenal diphosphate.

29. A method of forming a thermoplastic blend comprising coating a clay with a diphosphate blending the coated clay with a polymeric material consisting essentially of a polymethylmethacrylate, ethylene vinyl acetate and acrylonitrile butadiene styrene to form a masterbatch, blending said masterbatch with a thermoplastic polymer.

30. The method according to claim 29 wherein said clay is exfoliated in said polymeric material.

31. The method according to claim 30 wherein said diphosphate is heated to from about 50° C. to about 100° C. prior to coating said clay.
